(19) United States
(12) Patent Application Publication
(10) Pub. No.: US 2013/0233282 A1
(43) Pub. Date: Sep. 12, 2013

(54) METHOD FOR OPERATING AN INJECTION SYSTEM

(71) Applicants: Michael Reinstaedtler, Homburg/Saar (DE); Hans-Peter Scheurer, Marbach (DE); Karin Broecker, Marbach (DE); Robert Kuehner, Engelsbrand (DE); Uwe Gordon, Markgroeningen (DE); Michael Domhan, Leonberg (DE)

(72) Inventors: Michael Reinstaedtler, Homburg/Saar (DE); Hans-Peter Scheurer, Marbach (DE); Karin Broecker, Marbach (DE); Robert Kuehner, Engelsbrand (DE); Uwe Gordon, Markgroeningen (DE); Michael Domhan, Leonberg (DE)

(73) Assignee: Robert Bosch GMBH, Stuttgart (DE)

(21) Appl. No.: 13/820,982

(22) PCT Filed: Aug. 1, 2011
(86) PCT No.: PCT/EP11/63231

§ 371 Date: May 29, 2013

(30) Foreign Application Priority Data
Sep. 14, 2010 (DE) 10 2010 040 715.1
Dec. 13, 2010 (DE) 10 2010 062 883.2

(51) Int. Cl. F02D 41/30

(52) U.S. Cl. CPC F02D 41/30
USPC 123/478

(57) ABSTRACT

In a method for operating an injection system for a combustion engine, in an operating situation in which fuel is not requested by combustion engine, a valve is operated during at least one time interval in such a way that no fuel injection takes place, a valve element being moved in relation to at least one valve body by operating the valve.

### BACKGROUND OF THE INVENTION

1. Field of the Invention

The present invention relates to a method and a system for operating an injection system.

2. Description of the Related Art

Injection systems for internal combustion engines are designed to convey fuel from a tank to the combustion chamber of an internal combustion engine. An injection system usually includes in the proximity of the tank a low-pressure area having a low-pressure pump, fuel filters and fuel lines, as well as a high-pressure area having a high-pressure pump, fuel lines, distribution rails and injectors which supply the combustion chamber of the internal combustion engine with fuel at the time and volume as needed. The low-pressure area also includes a return system which supplies the leakages and return quantities of different components of the injection system back to the tank and/or a pre-feed system.

In modern timed injection systems, the computation of injection functions and the activation of injectors and other actuators for controlling the injection system and the internal combustion engine are carried out by a control unit.

Components of injection systems are generally always exposed to the fuel to be conveyed and are lubricated thereby in most cases, whereby wear is prevented at the contact areas of the moving and fixed parts. Functions of the injection system as well as its stability and service life thus depend on the properties of the fuel and its components. Now, if the chemical-physical fuel properties are changing by the supply of fuels, for example, which are not optimized for the injection system or due to the change in the fuel properties during the ongoing operation, functions of the injection system may be changed thereby.

One effect of the changing fuel properties on the injection system is, for example, the formation of deposits which may adhere to the surfaces of the components or the individual parts of the injection system. A deposit formation in diesel fuels may be caused, as far as known today, by metal soaps, aging polymer components due to bio additives in the fuel or by polymer components of certain detergents.

The reactions which result in the products of deposit formation are a function of temperature, a high temperature facilitating and accelerating the formation of deposits. Hot fuel ages faster than cold fuel, the hot fuel oxidizing and forming acids which facilitate a chemical reaction for the formation of deposits.

Movable components such as nozzle needles, switching valves, actuators, hydraulic couplers, etc., may suffer impairment in their movements. This impairment in the movement may result in a slight interference with the movement, a heaviness of the components to be moved, or potentially a complete blockage which does not allow any operation of the moving parts. The friction forces of the deposits are in this case greater than the operating forces applied to move the components. This results in an impairment of functions and in a malfunction of the injection system, whereby minor changes in the injection quantities, but also continuous injections or a complete absence of injections, may be caused.

Different possibilities are conceivable to detect deposit formation in injection systems and to reduce or even completely avoid its effects. It is important for an injection system, among other things, that deposit forming products are avoided in the first place with the aid of fuel properties. However, fuels may always have components which may cause a formation of deposits.

German Patent Publication DE 199 17 711 C2 describes a method for controlling an internal combustion engine having a high-pressure accumulator injection system, at least one pump conveying the fuel from a low-pressure area to a high-pressure area, the fuel entering the combustion chambers of the internal combustion engine via injectors. In this case, an actual value of the pressure in the high-pressure area is detectable using a pressure sensor and controlled to a setpoint value. Here, the injectors are used for controlling the pressure, the injectors being activatable in such a way that fuel does not enter the combustion chambers, but is conveyed from the high-pressure area to the low-pressure area.

### BRIEF SUMMARY OF THE INVENTION

With the aid of the measures provided within the scope of the present invention, it is possible to achieve, among other things, a purging and/or cooling of at least one valve, using which an injection is carried out in an injection system designed as a high-pressure injection system, for example, by operating same valve during a thrust phase and/or after the engine has been turned off (stopped).

The operation of the valves during the thrust phase or in a coasting mode is carried out in such a way that an undesirable injection does not take place. This is achieved by briefly activating the valve of a common rail injector, the activations being so short that they do not result in an opening of an injection nozzle of the valve and thus in an injection of fuel into a combustion chamber of a combustion engine.

The short activations which are caused during the thrust phase by so-called blank shot activations usually take place at low pressures of approximately 300 bar of the fuel which is supplied to the injection system for cooling and/or purging. The temperature level of the fuel supplied this briefly is thus lower, and the decompression of the fuel to a return pressure in the ducts and over a valve seat results only in a slight temperature increase of the fuel. According to a rough estimation, the temperature increase due to the decompression of the diesel fuel via a throttle is approximately 4.5 K per 100 bar. This means that in the case of a decompression of 2000 bar to an ambient pressure, the temperature in the fuel increases by approximately 90 K. If the pressure level of the injection system is only 300 bar, the temperature increase is only 14.5 K. This means that the fuel which flows through an activated valve during thrust phases is cooler by more than 70 K.

According to one embodiment of the present invention, a blank shot activation is an activation of a switching valve in the injection system or in a fuel injection system, the activation being so short that a fuel injection into the combustion chamber does not take place due to the inertia of the masses, springs, and fluids. A typical injector in the combustion engine is not a “directly controlled injector” but is switched by a magnetic or piezoelectric valve. A difference is made between the switching valve and the actual injector, the injection nozzle. An operation of the switching valve influences the forces acting on the injector, and thus on the injection nozzle, in such a way that it opens and fuel is able to enter the combustion chamber, and it closes again, thus interrupting the fuel flow. The activation of the switching valve typically results in a certain portion of the pressurized fuel being reset with the goal of influencing the pressure forces acting on the injector. This control quantity typically reenters the tank as a loss quantity.

During the blank shot activation, which may also be referred to as an activation without effect, the switching valve is activated without a response from the injector. This may be caused by the fact that the fuel pressure in a space must drop below a certain value before the injector actually switches, and the pressure does not drop below this value as a result of the short activation of the switching valve or servo-valve. Alternatively or additionally, a lag period is caused by the mechanical inertia of a piston/spring system between the switching valve and the injector, so that a short activation of the switching valve does not have any effect on the injector.

In addition to the cooling effect, a purging of the valve results in hot, aging-prone fuel being replaced by cooler, stable fuel. Both effects contribute to chemical reactions for deposit formation being prevented or slowed down.

The cooling and purging effectuated according to one embodiment of the present invention are functions of the injection system which may also be integrated retroactively into existing injection systems with the aid of a function of the control unit. Additional design modifications of components of the injection system are not required and additional components also do not need to be integrated into the injection system. The functions may be activated as needed in the case of operating conditions which represent a higher risk of deposit formation.

In another embodiment of the present invention, a growth of deposits is prevented on critical places after the engine has been turned off and thus a restart of the engine is ensured.

For this purpose, the valve is operated repeatedly by current feed after the engine has been turned off and the pressure, e.g., the rail pressure in a common-rail injection system, has been completely reduced. In this case, a duration of the current feed is not limited to short activation intervals, since an injection cannot take place due to the lack of rail pressure. Likewise, the valve activation may take place during a standstill long after the engine has been turned off.

With the aid of an at least one-time and/or repeated operation of the valve, e.g., with the aid of current feed, and with the aid of the resulting movement of at least one valve element or a component of the valve in relation to a fixed valve body, e.g., a movement of a valve needle or an armature as valve elements in relation to a base body as the at least one fixed, non-movable valve body of the valve, the growth of deposits after the engine has been turned off may be impaired, completely prevented, or reversed. In one specific embodiment of the present invention, the valve element designed as a valve needle or an armature and, if applicable, at least one other component of the valve are moved in relation to a housing as the at least one valve body.

During a standstill phase of the combustion engine, this measure may result in that deposits cannot form which interfere with the valve function during a subsequent start of the combustion engine.

Here too, it is not necessary to perform design modifications to prevent deposits, since this is also a function of the injection system.

The present invention may ensure a cooling of surfaces of the injection system which are at risk. This usually takes place due to the operation of the valves during the thrust phases and after engine standstill. During thrust phases, the rail pressure is significantly reduced compared to the usual injection operation. The supplied fuel is cold in relation to the material of the components of the injection system. If the fuel flows through the valve or along the duct, heat is dissipated from the critical areas and the temperature is reduced. The valve may thus be purged with the aid of this activation and hot fuel may be replaced by cooler fuel.

With the aid of the measures provided within the scope of the present invention, it is possible overall to slow down or to prevent a chemical reaction for deposit formation.

An operation of the valves after the combustion engine has been turned off makes it possible that in the presence of residual pressure in the injection system, hot fuel which may age during the following stationary phase or standstill phase is purged out and replaced by fuel which was exposed to a lower pressure and temperature level and is thus less likely to age. Since the deposit formation is thus prevented during the stationary phase, the function of the valve may be ensured in the case of a restart.

The functions of the injection system to be implemented in one specific embodiment of the present invention may be integrated into the control unit via software functions, so that components of the injection system may be controlled to implement at least one function provided within the scope of the method, so that a relative movement of deposit-prone components takes place.

The at least one provided function is activated as a function of operating parameters, e.g., an operating state of the combustion engine, the pressure, as well as the temperature of the injection system and/or the combustion engine, etc., and triggers an operation of the valves. This operation is configured in such a way that the operating behavior of the combustion engine is not interfered with. For the valve, this means, for example, that the activation is so short that an injection does not take place which has a negative effect on the running behavior and the emission of the engine. The described short activations are immediately interrupted and the cooling and purging functions are thus stopped as soon as a torque is requested from the combustion engine, e.g., in that the driver operates the accelerator pedal.

In one specific embodiment, the short activations for a short operation of the valve may also take place after the combustion engine has been turned off. In this case, an existing pressure of the injection system is reduced with the aid of the operation of the valve. A purging and cooling of the valve takes place as in the case of the operation in coasting mode. This function may be active permanently or temporarily after the engine has been turned off following a rail pressure reduction. An operation of the valve after the engine has been turned off impedes the growth of deposits and removes recently formed deposits during the shutdown time of the engine.

The deposits probably do not only develop during regular operation, but may also form when valves and actuators, etc., of the injection system are no longer operated, when the internal combustion engine or a combustion engine are turned off, for example. A formation of deposits may be prevented or at least reduced with the aid of the specific embodiments of the present invention.

The system according to the present invention is designed to carry out all steps of the presented method. Individual steps of this method may also be carried out by individual components of the system. Furthermore, functions of the system or functions of individual components of the system may be implemented as steps of the method. In addition, it is possible to implement steps of this method as functions of at least one component of the system or of the entire system.

Further advantages and embodiments of the present invention result from the description and the appended drawings.

It is understood that the above-mentioned features and the features to be elucidated below are usable not only in the given combination, but also in other combinations or alone without departing from the scope of the present invention.

### BRIEF DESCRIPTION OF THE DRAWINGS

FIG. 1 shows a flow chart for a function for carrying out a cooling and purging during a thrust phase within the scope of a first specific embodiment of the method according to the present invention.

FIG. 2 shows a diagram of a characteristic over time of operating parameters before and during the activation of the cooling and purging functions within the scope of a second specific embodiment of the method according to the present invention.

FIG. 3 schematically shows a first example of a valve of an injection system in which thick deposit layers form which impair a valve function.

FIG. 4 schematically shows the valve from FIG. 3 in which a formation of deposits does not take place when a third specific embodiment of the method according to the present invention is carried out.

FIG. 5 schematically shows a second example of a valve of an injection system in which deposit layers have formed which are removed by carrying out the fourth specific embodiment of the method according to the present invention.

FIG. 6 schematically shows a third example of a valve of an injection system in which thick deposit layers form which impair a valve function.

FIG. 7 schematically shows a specific embodiment of a system according to the present invention.

### DETAILED DESCRIPTION OF THE INVENTION

The present invention is illustrated schematically on the basis of specific embodiments in the drawings and is described in greater detail in the following with reference to the drawings.

The figures are described cohesively and comprehensively; identical reference numerals identify identical components.

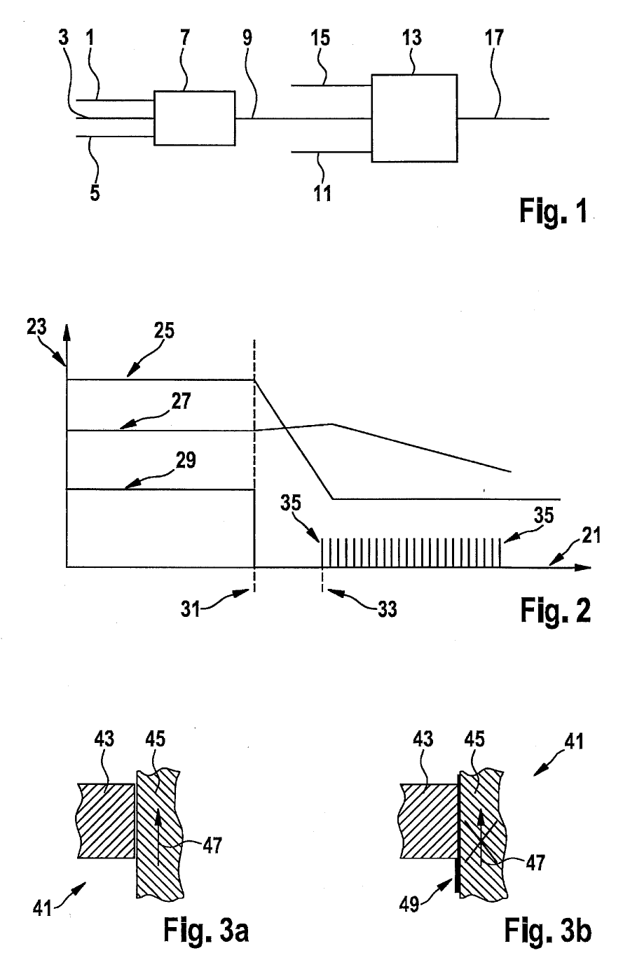

In the flow chart from FIG. 1 to illustrate a function, which takes place when a first specific embodiment of the method according to the present invention is carried out, a temperature 1 of a combustion engine, a temperature 3 of a fuel to be injected, as well as a dwell time 5, during which a load operation of the combustion engine and thus an injection phase take place, are incorporated in a computation 7 using which a temperature 9 of a valve of an injection system is computed at which fuel is injected into a combustion chamber of the combustion engine. However, temperature 9 of the valve may also be measured.

Ascertained temperature 9 of the valve as well as a value of pressure 11 of the fuel within the injection system are supplied to a function control 13. Furthermore, a piece of information is provided as a function of an operating state of the combustion engine, as to whether fuel is not requested for the combustion engine and thus a thrust phase 15 is present.

In the presence of a thrust phase 15, the combustion engine is tow-started by the motor vehicle in the case of a not-separated friction lock between the combustion engine and a power plant of the motor vehicle and thus remains in rotary motion.

In the described specific embodiment, the method is carried out when temperature 9 of the valve is high enough to cause chemical reactions due to which the fuel may cause a deposit formation in the valve. Another condition for carrying out the method is met if a desirable injection quantity of the fuel is zero, which is the case in the presence of a thrust phase 15 and also during the standstill phase of the combustion engine. Moreover, the carrying out depends on a third condition which is met if pressure 11 of the fuel is below a limiting value. In this case, short activations 17 are generated via function control 13 to operate the valve. During such short activations 17, which are provided here via blank shot activations, the valve is energized with a current whose current profile includes short-term, rectangular pulses (blank shots), and thereby temporarily operated and briefly opened. However, this does not cause the nozzle needle of the valve to lift so that injections are avoided when short activations 17 are used.

In the diagram from FIG. 2 regarding a characteristic of operating parameters in a second specific embodiment of the method according to the present invention, the time is plotted along an abscissa 21. Three curves for operating parameters, namely for a pressure 25 of the fuel and a temperature 27 of the valve, are plotted on an ordinate 23. A third curve represents a signal 29 for a fuel quantity requested for the injection. Here, a certain fuel quantity is requested up to a first point in time 31 t₁ to operate the combustion engine. In this case, signal 29 is provided according to an operation of an accelerator pedal of the motor vehicle. In the described specific embodiment of the method, it is provided that a requested fuel quantity is zero starting from first point in time 31 t₁. This may usually mean that the combustion engine is in a thrust phase starting from first point in time 31 t₁. After first point in time 31 t₁, it is initially the case that temperature 27 of the valve increases. However, pressure 25 of the fuel decreases. As soon as pressure 25 falls below a threshold, multiple short activations 35 are provided at a second point in time 33 t₂ whereby the valve is temporarily operated. Already after first short activations 35, pressure 25 reaches a minimum. Temperature 27 of the valve is also simultaneously reduced.

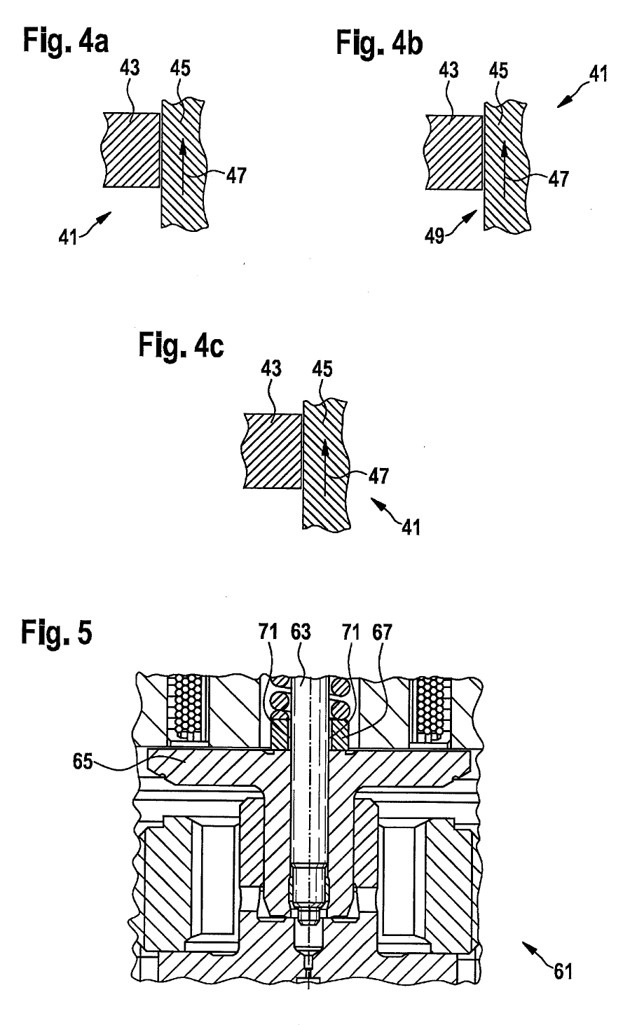

FIGS. 3 and 4 each schematically show components of a valve 41 of an injection system, which is designed as a needle valve, a usually fixed valve body 43 as well as a valve needle 45, which is movable in relation to valve body 43, being illustrated as components.

In the illustration in FIG. 3a, valve 41 is in an operating situation which is referred to as an injection phase and in which a movement 47 of valve needle 45 as the valve element takes place in relation to valve body 43. Due to this movement 47, which is symbolized by an arrow, a deposit formation caused by fuel is prevented on valve needle 45.

The illustration from FIG. 3b shows valve body 43 and valve needle 45 at a point in time Δt after the combustion engine has been turned off. During a stationary phase after the combustion engine has been turned off, a movement 47 does not take place (crossed out arrow) in relation to valve body 43. After above-mentioned time interval Δt, deposits 49 form on valve needle 45 as well as valve body 43 due to the still present fuel, which may prevent or at least limit a movement 47 of valve needle 45 during a restart of the combustion engine.

FIG. 3 thus also shows the problem of a growth of deposits in a valve 41, designed here as a needle valve, without the function proposed within the scope of the present invention. Valve 41 is schematically illustrated here in the lower end position of valve needle 45 in a closed state and is designed as a servo-control valve of a common rail injection system.

A third specific embodiment of the method according to the present invention is described based on FIG. 4. Here, FIG. 4a shows the same situation as FIG. 3a in which a movement 47 of valve needle 45 takes place in relation to valve body 43 during an injection phase of the combustion engine, thus preventing a deposit formation. FIG. 4b shows valve 41 after the combustion engine has been turned off during a so-called stationary phase when the third specific embodiment of the method according to the present invention is carried out. In this case, valve 41 is activated and operated at least once through short or, if necessary, long activations. With the aid of this measure, a deposit formation is disrupted so that not a thick, but only a thin deposit layer 49 may form on valve needle 45 from the deposited fuel, this deposit layer, however, not impeding a movement 47 of valve 41.

FIG. 4c shows valve 41 after a time interval Δt after the combustion engine has been turned off. Due to deposit layer 49 being only thin, a movement of valve 41 is unimpededly possible at a restart of the engine.

If, instead of the stationary phase, a thrust phase is alternatively provided for the combustion engine after the injection phase, a situation results which is similar to the situation shown with reference to FIG. 4b. During the thrust phase, valve 41 is only operated through short activations instead of through longer activations, as is provided in the case of the stationary phase. However, this also results in a movement 47 of valve needle 45, whereby a deposit formation is at least reduced.

With the aid of the function proposed within the scope of the present invention, a formation of deposits which impair the function does not take place due to repeated activation during a deposit forming phase after the engine has been turned off.

The deposit formation is disrupted due to the repeated movement of valve needle 45 during the deposit formation and/or condensation of fuel and is limited to an extent which is not critical for the functioning of the valve.

FIG. 5 schematically shows another example for a pressure-balanced valve 61, which is designed as a sleeve valve, having an armature bolt 63, an armature 65, as well as a valve spring adjustment disk 67. Moreover, deposits 71 are indicated in FIG. 5 which are deposited on armature bolt 63 in the closed state of valve 61 and may impede an opening of valve 61.

In a fourth specific embodiment of the method according to the present invention, valve 61, which is designed as a sleeve valve, is operated in an operating situation of the combustion engine during at least one time interval in such a way that thereby no fuel injection takes place. By operating this sleeve valve, a valve element, here armature 65, is moved via an electromagnet in relation to a valve body, here armature bolt 63, which is not actively moved, and/or in relation to valve spring adjustment disk 67. In this way, deposits 71 are removed and/or a new formation of deposits 71 is prevented.

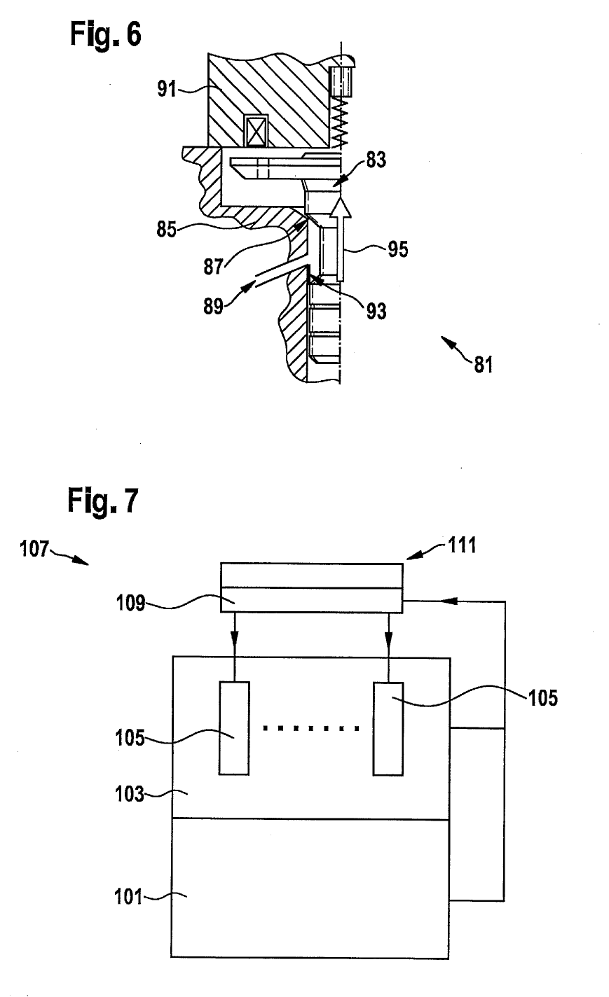

FIG. 6 schematically shows a third example for a valve 81 having a valve needle 83, a valve body 85, a valve seat 87, a channel 89, and a coil core 91. In this third example of a valve 81, a deposit formation 93 may also result during a stationary phase, which may, however, be remedied by a movement of valve needle 83, which is provided within the scope of the method according to the present invention.

The method according to the present invention may be carried out for all valves 61, 81 of injection systems whose functions may be influenced by control instructions.

FIG. 7 schematically shows a combustion engine 101 as well as an injection system 103 having multiple valves. Moreover, FIG. 7 schematically shows a system 107 for operating injection system 103 using a control module 109 which is situated in a control unit 111. Control module 109 is connected to injection system 103 and combustion engine 101 via feed lines for the exchange of operating parameters of injection system 103 and combustion engine 101. Control module 109 is able to activate and thus operate valves 105 via additional feed lines.

Control module 109 controls in an operating situation, in which fuel is not requested by combustion engine 101 so that a torque request is not present and an injection is not provided, at least one valve 105 during at least one time interval in such a way that thereby no fuel injection takes place as a result. A function for carrying out the method may be implemented as software in control module 109.

The method may be carried out during a thrust phase of combustion engine 101, valve 105 being operated through a short activation during at least one short time interval. Alternatively or additionally, the method may be carried out after combustion engine 101 has been turned off, it also being possible to activate valve 105 for longer time intervals.

As another condition for carrying out the method, it is checked whether a pressure of the fuel in injection system 103 exceeds a threshold value, the supplied fuel having a lower pressure than the fuel present in the injection system. It may also be checked whether a temperature of the fuel in the injection system exceeds a threshold value, the supplied fuel having a lower temperature than the fuel present in the injection system.

By operating valve 105, a valve element is moved in relation to at least one fixed valve body, e.g., a base body and/or a housing of valve 105. Moreover, valve 105 is cooled and/or purged by the supplied fuel which has a lower pressure as well as a lower temperature than the already present fuel.

By operating valve 105, a valve element, e.g., a valve needle in a needle valve or an armature in a sleeve valve, is moved in this case in relation to at least one valve body, e.g., a base body or a housing of valve 105, which is usually fixed. The method may be terminated in that a torque is requested from combustion engine 101.

1-10. (canceled)

11. A method for operating an injection system for a combustion engine, comprising:
selectively operating a valve system, during at least one time interval in an operating situation in which (i) fuel is not requested by the combustion engine and (ii) a pressure of fuel is below a predefined limit, to ensure no fuel injection takes place.

12. The method as recited in claim 11, wherein the method is carried out when a temperature of the valve system is above a threshold value.

13. The method as recited in claim 12, wherein the method is carried out during a thrust phase of the combustion engine, the valve system being operated during at least one activation period.

14. The method as recited in claim 12, wherein the method is carried out after the combustion engine has been turned off.

15. The method as recited in claim 11, wherein the valve system is configured as one of (i) a needle valve system having a valve needle movable in relation to the valve body, or (ii) a sleeve valve system having an armature movable in relation to the valve body.

16. The method as recited in claim 14, wherein the method is terminated when a torque is requested from the combustion engine.

17. The method as recited in claim 14, wherein the valve system is configured to be at least one of cooled and purged by fuel supplied to the injection system.

18. A system for operating an injection system for a combustion engine, comprising:
a control module selectively activating a valve system, during at least one time interval in an operating situation in which (i) fuel is not requested by the combustion engine and (ii) a pressure of fuel is below a predefined limit, to ensure no fuel injection takes place.

19. The system as recited in claim 18, wherein the control module is configured as a component of a computerized control unit.
